(19) United States
(12) Patent Application Publication
(10) Pub. No.: US 2012/0162099 A1
(43) Pub. Date: Jun. 28, 2012

(54) TOUCH SCREEN

(75) Inventors: Dong Sik YOO, Seoul (KR); Hee Bum LEE, Gyunggi-do (KR); Kyoung Soo CHAE, Seoul (KR); Yong Soo OH, Gyunggi-do (KR); Yun Ki HONG, Gyunggi-do (KR); Jong Young LEE, Gyunggi-do (KR)

(73) Assignee: SAMSUNG ELECTRO-MECHANICS CO., LTD., Gyunggi-do (KR)

(21) Appl. No.: 13/083,404

(22) Filed: Apr. 8, 2011

(30) Foreign Application Priority Data
Dec. 24, 2010 (KR) 10-2010-0134688

(51) Int. Cl. G06F 3/041

(52) U.S. Cl. 345/173

(57) ABSTRACT

Disclosed herein is a touch screen 100 designed to control an image displayed on image display units 140 and 150 on both-sides of the touch screen. The touch screen 100 according to the present invention may overcome an obscured screen problem caused by an input device, increase production yield while reducing a process time of the touch screen 100 by simultaneously forming transparent electrodes and electrode wires on a transparent substrate and, after forming an image display unit and an active region on the transparent substrate, folding the transparent substrate, and minimize an area of a bezel region.

### CROSS REFERENCE TO RELATED APPLICATION

This application claims the benefit of Korean Patent Application No. 10-2010-0134688, filed on Dec. 24, 2010, entitled “Touch Screen” which is hereby incorporated by reference in its entirety into this application.

### BACKGROUND OF THE INVENTION

1. Technical Field

The present invention relates to a touch screen.

2. Description of the Related Art

With advanced computers using digital technologies, computer-assisted equipment has also been developed. Further, personal computers, portable transmission devices, other personal private information processing devices, or the like, normally execute text and graphic functions by using various input devices such as a keyboard, a mouse, or the like.

However, with advanced mobile communication technologies, terminals such as a mobile phone, a PDA, a navigation, or the like, are no longer simple devices for displaying textual information only, but have developed as complex and various kinds of devices with increased performance to include multimedia such as audio, video, wireless internet web browser, or the like. Therefore, a display screen is required to be increased within a limited size of an electronic data terminal and, to meet this need, a touch screen type display scheme has increasingly attracted attention.

Such a touch screen is a tool which is typically mounted on a display face of an image display device such as a flat panel display device, for example, an electronic notebook, a liquid crystal display device (LCD), a plasma display panel (PDP), an electroluminescence (EL), or the like, as well as a cathode ray tube (CRT), to allow a user to select desired information while watching the image display device.

However, since a display scheme using a touch screen is embodied by a combination of a screen and a coordinate input means, a variety of alternative input means including the human body is generally required to control an image display device. In this case, the input means may obscure a screen of an image display unit which causes inconvenience in operating the touch screen and increases the occurrence of mis-operation.

Further, in order that a user can exactly recognize an operating command and activate the same, it is required to correctly sense a position of the input signals and, for this purpose, a transparent electrode should be fabricated to be even more compact. Consequently, the number of electrode wires in the touch screen is increased, which in turn causes an increase in area of a bezel region of the touch screen, and as a result, it is difficult to decrease the size of an electronic product.

### SUMMARY OF THE INVENTION

The present invention has been made in an effort to provide a touch screen fabricated by designing the touch screen to enable drive signals to be input on both sides of the touch screen, to thereby overcome obscured screen problems due to an input device, and by simultaneously forming transparent electrodes and electrode wires to thereby increase production yield while reducing a process time.

According to a preferred embodiment of the present invention, there is provided a touch screen including: a first transparent substrate that is partitioned into a first region, a second region and a first bent region present between the first and second regions, and is folded by the first bent region, to allow one side of the first region to face one side of the second region; first transparent electrodes formed on the other side of the first region in the first transparent substrate; first electrode wires extending from the first transparent electrodes to the first bent region; second transparent electrodes formed on the other side of the second region in the first transparent substrate; second electrode wires extending from the second transparent electrodes to the first bent region; a first image display unit formed on one side of the first region in the first transparent substrate; and a second image display unit formed on one side of the second region in the first transparent substrate.

Here, the touch screen may further include a protective layer formed on the other side of the first transparent substrate to be applied to the first transparent electrodes and the second transparent electrodes, and an adhesive member interposed between the first image display unit and the second image display unit.

In addition, the touch screen may further include: a second transparent substrate that is partitioned into a third region corresponding to the first region, a fourth region corresponding to the second region, and a second bent region corresponding to the first bent region and present between the third and fourth regions, and is stacked over the first transparent substrate to allow one side the second transparent substrate to face the other side of the first transparent substrate; third transparent electrodes formed on the other side of the third region in the second transparent substrate; third electrode wires extending from the third transparent electrodes to the second bent region; fourth transparent electrodes formed on the other side of the fourth region in the second transparent substrate; fourth electrode wires extending from the fourth transparent electrodes to the second bent region; and an adhesive layer bonding the other side of the first transparent substrate with the one side of the second transparent substrate.

The first transparent electrodes may have bar patterns, rectangular patterns or diamond-shaped patterns, which are repeatedly arranged.

The second transparent electrodes may have bar patterns, rectangular patterns or diamond-shaped patterns, which are repeatedly arranged.

Each of the first transparent electrodes and the second transparent electrodes may be formed of a conductive polymer.

The conductive polymer may include poly-3,4-ethylenedioxythiophene/polystyrene sulfonate (PEDOT/PSS), polyaniline, polyacetylene or polyphenylenevinylene.

The third transparent electrodes may have bar patterns, rectangular patterns or diamond-shaped patterns, which are repeatedly arranged.

The fourth transparent electrodes may have bar patterns, rectangular patterns or diamond-shaped patterns, which are repeatedly arranged.

Each of the third transparent electrodes and the fourth transparent electrodes may be formed of a conductive polymer.

The conductive polymer may include poly-3,4-ethylenedioxythiophene/polystyrene PEDOT/PSS, polyaniline, polyacetylene or polyphenylenevinylene.

An image displayed on the first image display unit may correspond to an image displayed on the second image display unit.

The first transparent electrodes and the first electrode wires may be simultaneously formed and the second transparent electrodes and the second electrode wires may be simultaneously formed.

The first electrode wires and the second electrode wires may be formed to extend toward the first bent region to thereby allow both of them to be gathered at one end of the first bent region.

Additionally, the third transparent electrodes and the third electrode wires may be simultaneously formed and the fourth transparent electrodes and the fourth electrode wires may be simultaneously formed.

The third electrode wires and the fourth electrode wires may be formed to extend toward the second bent region to thereby allow both of them to be gathered at one end of the second bent region.

### BRIEF DESCRIPTION OF THE DRAWINGS

FIG. 1 is a cross-sectional view illustrating a touch screen according to a first preferred embodiment of the present invention;

FIG. 2 is a cross-sectional view illustrating a touch screen according to a second preferred embodiment of the present invention;

FIG. 3 is a perspective view illustrating a touch screen according to the first preferred embodiment of the present invention;

FIG. 4 is a plan view illustrating a first transparent substrate and a second transparent substrate as essential configurations of the present invention;

FIGS. 5 through 7 are plan views illustrating a first transparent substrate on which transparent electrodes as essential configurations of the present invention are provided;

FIG. 8 is a perspective view illustrating the first transparent substrate or the second transparent substrate, which are essential configurations of the present invention;

FIG. 9 is a perspective view illustrating a first transparent substrate as an essential configuration of the first preferred embodiment of the present invention; and

FIGS. 10 and 11 are perspective views illustrating a first transparent substrate and a second transparent substrate which are essential configurations of the second preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments according to the present invention will be described in detail with reference to the accompanying drawings.

### First Preferred Embodiment of Invention

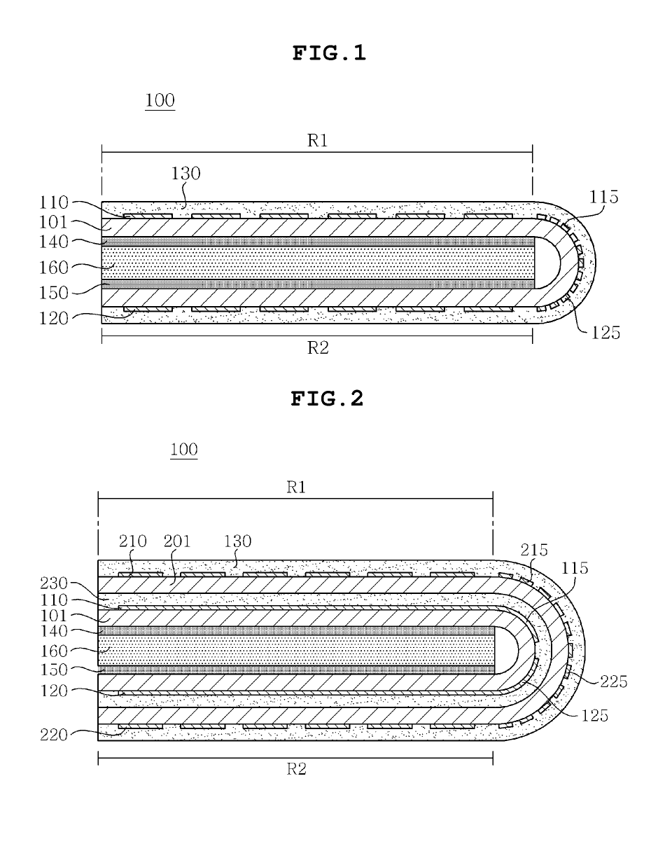

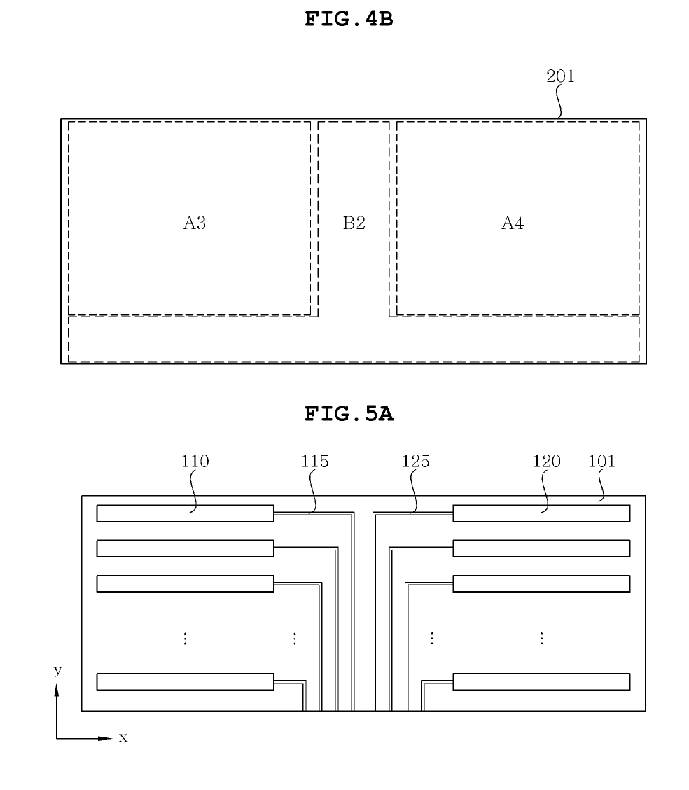

FIG. 1 is a cross-sectional view showing a touch screen according to a first preferred embodiment of the present invention, and FIG. 3 is a perspective view showing the touch screen according to the first preferred embodiment of the present invention.

As shown in FIG. 1, a touch screen 100 according to the first embodiment of the present invention includes a first transparent substrate 101, first transparent electrodes 110 and second transparent electrodes 120, first electrode wires 115 and second electrode wires 125, and a first image display unit 140 and a second image display unit 150, and the like.

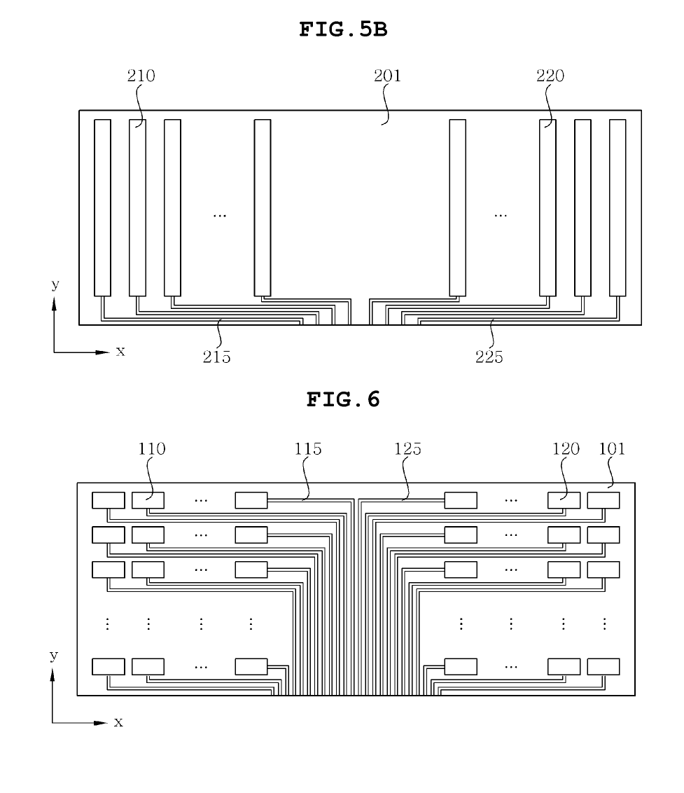

The first transparent substrate 101 may function to afford a region on which transparent electrodes (the first transparent electrodes 110 and the second transparent electrodes 120) and electrode wires (the first electrode wires 115 and the second electrode wires 125) are provided. As shown in FIG. 4A, the first transparent substrate 101 is partitioned into a first region A1, a second region A2 and a first bent region B1. One side of the first region A1 may have a first image display unit 140 adhered thereon while one side of the second region A2 may have a second image display unit 150 adhered thereon, as described below. Additionally, the other side of the first region A1 may be a first active region (R1; see FIG. 1) on which the first transparent electrodes 110 and a part of the first electrode wires 115 are formed to recognize a touch of an input device. Similarly, the other side of the second region A2 may be a second active region (R2; see FIG. 1) on which the second transparent electrodes 120 and a part of the second electrode wires 125 are formed to recognize a touch of an input device. Meanwhile, the first bent region B1 present between the first region A1 and the second region A2 may be referred to as a bezel region, on which the first electrode wires 115 extending from the first transparent electrodes 110 and the second electrode wires 125 extending from the second transparent electrodes 120 are provided. Specifically, the first transparent substrate 101 may be folded to allow one side of the first region A1 to closely face one side of the second region A2, since the first bent region B1 is formed in a folded shape.

Here, the first transparent substrate 101 should have frequent intensity sufficient to support the transparent electrodes 110 and 120 as well as the electrode wires 115 and 125, and good transparency allowing a user to recognize images provided by the image display units 140 and 150. In addition, excellent bending properties or flexibility are required. In consideration of the supporting force, transparency and flexibility, as described above, the first transparent substrate 101 may be formed using polyethylene terephthalate (PET); however, a material of the first transparent substrate is not particularly limited thereto. In fact, other than PET, the first transparent substrate may be formed by using plastic materials having favorable flexibility, for example, polyethersulfone (PES), polycarbonate (PC), polymethylmethacrylate (PMMA), polyethylene naphthalate (PEN), cyclo-olefin polymer (COC), a triacetylcellulose (TAC) film, a polyvinyl alcohol (PVA) film, a polyimide (PI) film, polystyrene (PS), biaxially oriented polystyrene (BOPS containing K resin), or the like.

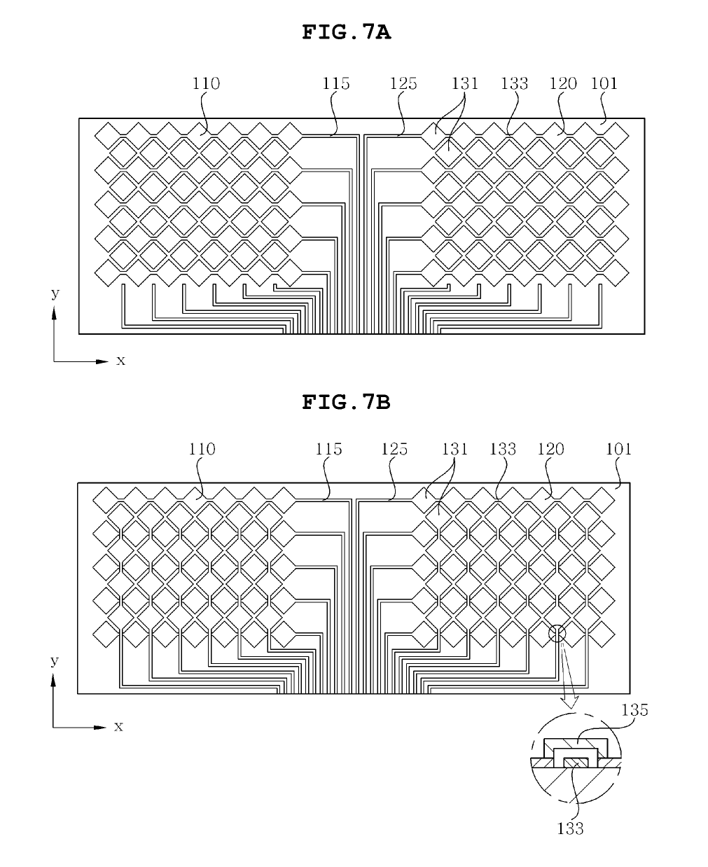

The transparent electrodes (the first transparent electrodes 110 and the second transparent electrodes 120) function to sense an input signal in order to recognize a touch coordinate in a control unit (not shown) when the input device touches the touch screen, and may be formed on the other side of the first region A1 and the other side of the second region A2 in the first transparent substrate 101. A shape of each of the first transparent electrodes 110 and the second transparent electrodes 120 may have bar patterns (see FIG. 5), rectangular patterns (see FIG. 6) or diamond-shaped patterns (see FIG. 7), each being repeatedly arranged at a predetermined interval. However, the shape of patterns is not particularly restricted thereto and, of course, may include any one known in the art. Meanwhile, although the first transparent electrodes 110 may have the same shape as the second transparent electrodes 120, the shapes thereof do not necessarily correspond to each other, since each of the first transparent electrodes 110 and the second transparent electrodes 120 senses independent input signals. The bar pattern, rectangular pattern and diamond-shaped pattern are formed on the same layer on the other side of the first transparent substrate 101. Specifically, for the transparent electrodes 110 and 120 having the diamond-shaped patterns shown in FIG. 7, X-axis direction and Y-axis direction electrodes may be simultaneously arranged on the same layer to thereby embody a simple structure and superior sensing property of input signals. In order to form the diamond-shaped patterns on the same layer, a bridge 135 may be used to isolate cross patterns from each other. More particularly, as shown in FIG. 7A, sensing units 131 and connection parts 133 are repeatedly arranged in X-axis direction, while the sensing units 131 are repeatedly arranged in Y-axis direction, and then, as shown in FIG. 7B, these sensing units 131 arranged in Y-direction are interconnected by bridges 135 interposed therebetween to thereby prevent electrical conduction between the connection units 133. In this regard, the sensing units 131 are a unit sensing the variation in capacitance when the input device comes into contact with the touch screen 100, while the connection parts 133 are a part to connect the adjacent sensing units 131.

Herein, the transparent electrodes 110 and 120 may be fabricated by using a conductive polymer having excellent flexibility and using a simple coating process, although indium tin oxide (ITO) typically used in the art may be employed. At this time, the conductive polymer may include, for example, poly-3,4-ethylenedioxythiophene/polystyrene sulfonate (PEDOT/PSS), polyaniline, polyacetylene, polyphenylenevinylene, or the like.

The electrode wires (the first electrode wires 115 and the second electrode wires 125) may be provide on the first bent region B1 in the first transparent substrate 101. The first electrode wires 115 extend from the first transparent electrodes 110 to receive electric signals while the second electrode wires 125 extend from the second transparent electrodes 120 to receive electric signals. In particular, the electrode wires 115 and 125 extending from the transparent electrodes 110 and 120 may be formed to reach the first bent region B1 and be gathered at one end of the first bent region B1. By gathering the electrode wires 115 and 125 in the first bent region B1 of the first transparent substrate 101, an area of a bezel region may be minimized to thereby utilize an active area more broadly. Alternatively, the electrode wires 115 and 125 gathered at one end of the first bent region B1 may be connected to a flexible cable of a printer (not shown). When the electrode wires 115 and 125 are concentrated at one end of the first bent region B1, a single control unit may easily execute integrated control and a size of an assistant device, on which the touch screen 100 is mounted, may be reduced.

In general, the transparent electrodes 110 and 120 may be formed by: a dry process such as sputtering, evaporation, or the like; a wet process such as dip coating, spin coating, roll coating, spray coating, or the like; or a direct patterning process such as screen printing, gravure printing, inkjet printing, or the like. Further, the electrode wires 115 and 125 may be formed by screen printing, gravure printing, inkjet printing, or the like. When the foregoing methods for forming the transparent electrodes 110 and 120 or the electrode wires 115 and 125 are employed, the transparent electrodes 110 and 120 as well as the electrode wires 115 and 125 may be sequentially formed.

However, a method for manufacturing the touch screen 100 according to the present invention may include simultaneous formation of the transparent electrodes 110 and 120 and the electrode wires 115 and 125 on the first transparent substrate 101. If the transparent electrodes 110 and 120 and the electrode wires 115 and 125 are formed on the first transparent substrate 101 at the same time, a manufacturing process thereof may be simplified to thereby reduce production costs. In this regard, the screen printing, the gravure printing or the ink-jet printing is preferably applied, however, the manufacturing process is not particularly restricted thereto, so long as a technical concept of simultaneously forming the transparent electrodes 110 and 120 as well as the electrode wires 115 and 125 may be satisfied.

On the other hand, a material of the electrode wires 115 and 125 is preferably Ag paste having superior electrical conductivity or a material consisting of organic Ag, however, is not particularly limited thereto but may include low resistivity metals, for example, conductive polymers, carbon black (including CNT), metal oxides such as ITO, metals, or the like. As described above, when the transparent electrodes 110 and 120 as well as the electrode wires 115 and 125 are simultaneously formed, a material of the electrode wires 115 and 125 is substantially the same as the transparent electrodes 110 and 120. Specifically, the conductive polymers such as poly-3,4-ethylenedioxythiophene/polystyrene sulfonate (PEDOT/PSS), polyaniline, polyacetylene, polyphenylenevinylene, or the like, may be adopted.

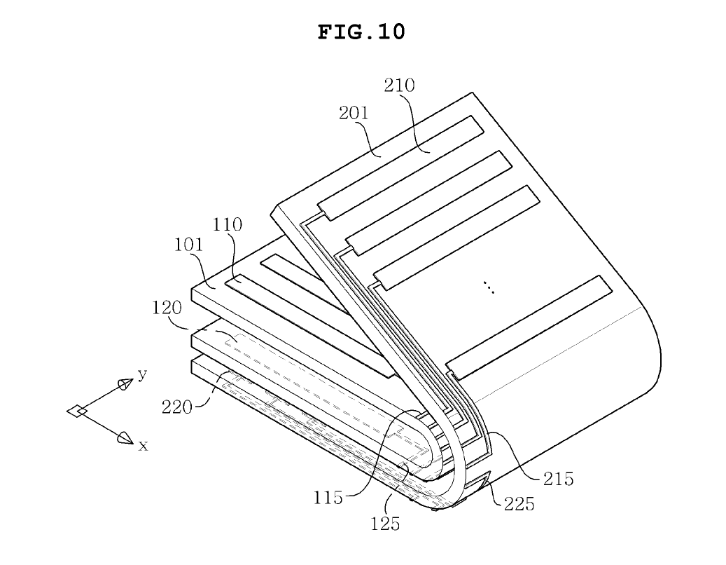

FIG. 9 is a perspective view illustrating the first transparent substrate 101 in a folded state after the transparent electrodes 110 and 120 as well as the electrode wires 115 and 125 are formed on the transparent substrate 101, according to a first preferred embodiment of the present invention. According to this drawing, in order to accurately illustrate an area on which the transparent electrodes 110 and 120 as well as the electrode wires 115 and 125 are formed, other components have been omitted. Substantially, the first transparent substrate 101 may be folded after a protective layer 130 is formed on the other side of the first transparent substrate 101. FIG. 9 shows the transparent electrodes 110 and 120 on which rectangular patterns are regularly repeated and arranged at a predetermined interval. Although not illustrated in FIG. 9, transparent electrodes may also be formed to have bar patterns or diamond-shaped patterns, other than such rectangular patterns, which are repeatedly arranged.

The image display units (the first image display unit 140 and the second image display unit 150) function to output images and may include a liquid crystal display (LCD) device, a plasma display panel (PDP), an electroluminescence (EL), a cathode ray tube (CRT), or the like. The first image display unit 140 may be provided on one side of the first region A1 in the first transparent substrate 101 while the second image display unit 150 may be provided on one side of the second region A2 in the second transparent substrate 201.

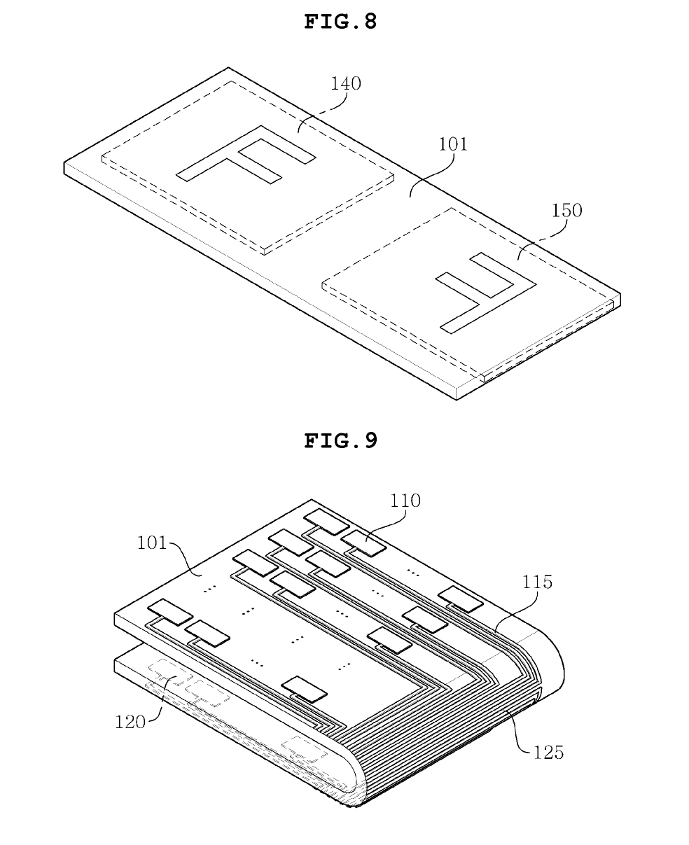

FIG. 8 is a perspective view illustrating a condition of the first transparent substrate 101 before folding the same by bending the first bent region B1 (see FIG. 4A) after the first image display unit 140 and the second image display unit 150 are formed on one side of the first transparent substrate 101. In this case, the image displayed on the first image display unit 140 corresponds to the image displayed on the second image display unit 150. In other words, when viewing at the other side of the first transparent substrate 101, an image transmitted through the first region A1 and an image transmitted through the second region A2 may have symmetrical images of each other. Therefore, images viewing at both sides of the first transparent substrate after folding the first transparent substrate 101 may correspond to each other.

Meanwhile, the first image display unit 140 and the second image display unit 150 may be bonded by an adhesive member 160. Without particular limitation, the adhesive member 160 used herein may include an optical clear adhesive (OCA) or a double adhesive tape (DAT), or the like.

The protective layer 130 may have a role of protecting the first transparent electrodes 110, the second transparent electrodes 120, the first electrode wires 115 and the second electrode wires 125, all of which are provided on the other side of the first transparent substrate 101. The protective layer 130 may include an optical transparent adhesive and, for example, may consist of an optical clear adhesive (OCA) or a pressure sensitivity adhesive (PSA).

In the detailed description of the present invention, an input part on the other side of the first region A1 is defined as a first active region R1 while another input part on the other side of the second region A2 is called a second active region R2. According to the present invention, paired image display units and transparent electrodes (that is, a pair of the first transparent electrodes 110 and the first image display unit 140, and a pair of the second transparent electrodes 120 and the second image display unit 150) are respectively partitioned in the first transparent substrate 101. However, the first electrode wires 115 extending from the first transparent electrodes 110 toward the first bent region B1 and the second electrode wires 125 extending from the second transparent electrodes 120 toward the first bent region B1 are gathered at one end of the first bent region B1, and then, connected to a single control unit. The first image display unit 140 and the second image display unit 150 according to the present invention may be controlled as a single interface. Therefore, if either of the first active region R1 and the second active region R2 is selected and receives an applied input signal, the sensed input signal may allow an electric signal to be transmitted to the single interface through the control unit. Then, an operating signal sent from the interface to the touch screen 100 may be equally transferred to both the first image display unit 140 and the second image display unit 150. Consequently, regardless of whether the variation in capacitance due to input signals is sensed by either of the active regions (the first active region R1 or the second active region R2), the same order is transmitted to these two image display units (140, 150) to thereby embody a single output image.

### Second Preferred Embodiment of Invention

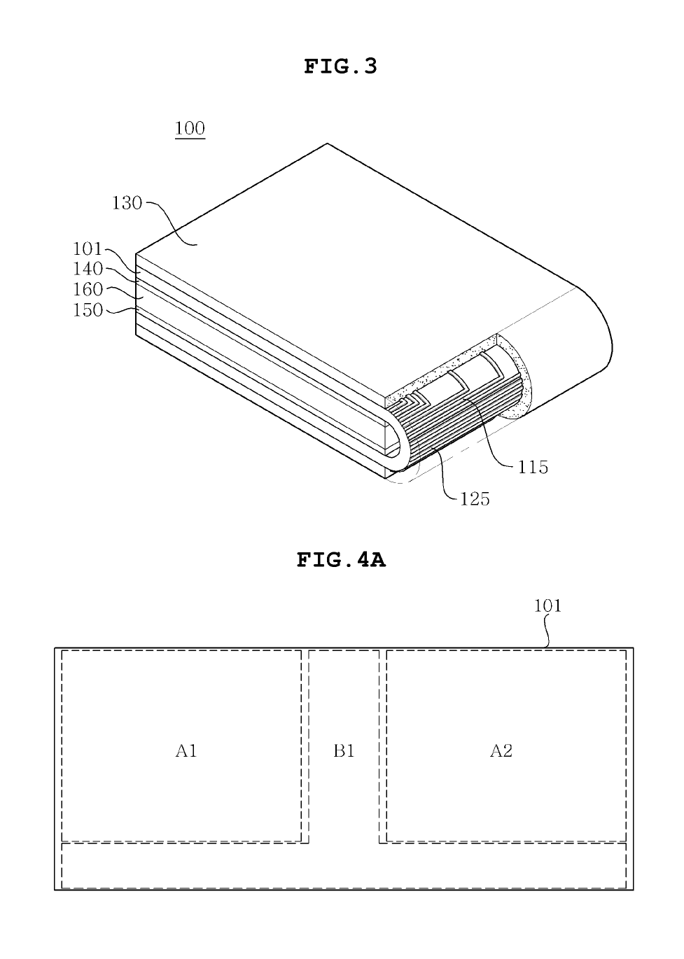

FIG. 2 is a cross-sectional view illustrating a touch screen according to a second preferred embodiment of the present invention.

As shown in FIG. 2, a touch screen 100 according to the second preferred embodiment of the present invention may be fabricated in a double-structure, including: a first transparent substrate 101 on which transparent electrodes 110 and 120, as well as electrode wires 115 and 125, are formed; a second transparent substrate 201 on which transparent electrodes (third transparent electrodes 210 and fourth transparent electrodes 220), as well as electrode wires (third electrode wires 215 an fourth electrode wires 225), are formed; two image display units 140 and 150; and an adhesive layer 230. That is, one side of the second transparent substrate 201 is arranged to face the other side of the first transparent substrate 101 and both of them are bonded by the adhesive layer 230. Here, the first transparent substrate 101 is folded to allow the first transparent electrodes 110 and the second transparent electrodes 120 to face outward and, likewise, the second transparent substrate 201 is folded to allow the third transparent electrodes 210 and the fourth transparent electrodes 220 to face outward, thereby enabling the first transparent electrodes 110 and the second transparent electrodes 120 to correspond to the third transparent electrodes 210 and the fourth transparent electrodes 220, respectively.

Shapes and constitutional materials of the first transparent substrate 101, the first transparent electrodes 110 and the second transparent electrodes 120, and the first electrode wires 115 and the second electrode wires 125 are substantially the same as described in the foregoing first preferred embodiment of the present invention. That is, the first image display unit 140 is provided on one side of the first region A1 and the second image display unit 150 is provided on one side of the second region A2 in the first transparent substrate 101. On the other hand, the first transparent electrodes 110 are formed on the other side of the first region A1 and the second transparent electrodes 120 are formed on the other side of the second region A2 in the first transparent substrate 101. In addition, the first electrode wires 115 and the second electrode wires 125 are gathered in the first bent region B1.

Meanwhile, as shown in FIG. 4B, the second transparent substrate 201 is partitioned into a third region A3 corresponding to the first region A1, a fourth region A4 corresponding to the second region A2, and a second bent region B2 corresponding to the first bent region B1, which is present between the third region A3 and the fourth region A4. The other side of the third region A3 in the second transparent substrate 201 is an area on which the third transparent electrodes 210 and a part of the third electrode wires 215 are formed to recognize a touch of an input device. Similarly, the other side of the fourth region A4 in the second transparent substrate 201 is an area on which the fourth transparent electrodes 220 and a part of the fourth electrode wires 225 are formed to recognize a touch of the input device. One side of the third region A3 in the second transparent substrate 201 is a first active region R1 while one side of the fourth region A4 in the second transparent substrate 201 is a second active region R2 (see FIG. 2). Further, the third electrode wires 215 extend from the third transparent electrodes 210 and are placed in the second bent region B2, while the fourth electrode wires 225 extend from the fourth transparent electrodes 220 and are placed in the second bent region B2. The second transparent substrate 201 is stacked over the first transparent substrate 101 to allow one side of the second transparent substrate 201 face the other side of the first transparent substrate 101, and then, folded by the first and second bent regions B1 and B2.

Similar to the first transparent electrodes 110 or the second transparent electrodes 120, each of the third transparent electrodes 210 and the fourth transparent electrodes 220 may have a shape of bar patterns (see FIG. 5), rectangular patterns (see FIG. 6) or diamond-shaped patterns (see FIG. 7), which are repeatedly arranged at a predetermined interval. However, without being particularly limited thereto, the transparent electrodes may of course have any pattern well known in the art. Further, functions and constitutional materials of the second transparent substrate 201, the third transparent electrodes 210 and the fourth transparent electrodes 220, the third electrode wires 215 and the fourth electrode wires 225 are respectively the same as the first transparent substrate 101, the first transparent electrodes 110 and the second transparent electrodes 120, the first electrode wires 115 and the second electrode wires 125. Accordingly, the repetitive description of the foregoing will be omitted.

Further, one side of the second transparent substrate 201 is bonded to the other side of the first transparent substrate 101 by the adhesive layer 230. A size of the adhesive layer 230 is substantially identical to that of a rim of the first transparent substrate 101 or the second transparent substrate 201. Here, the adhesive layer 230 may be formed of a transparent material not to interrupt the user who recognizes images output from the image display units 140 and 150, for example, using an optical clear adhesive (OCA).

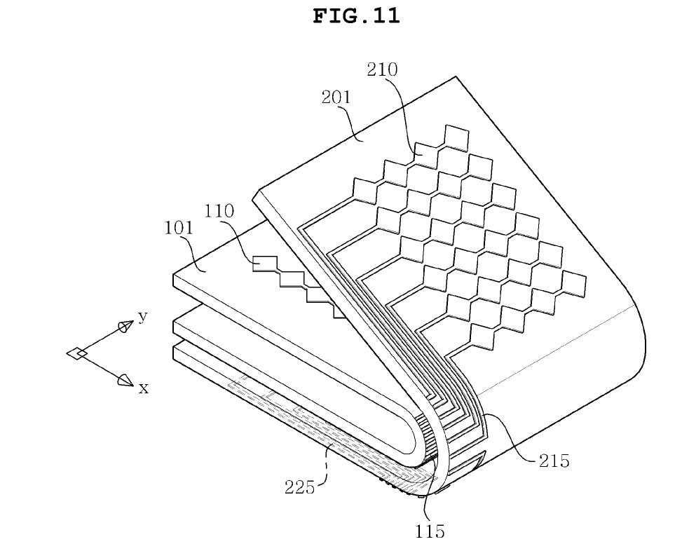

FIGS. 10 and 11 are perspective views illustrating a first transparent substrate and a second transparent substrate as essential configurations of the second preferred embodiment of the present invention. In order to clearly illustrate areas on which the transparent electrodes 110 and 120 of the first transparent substrate 101 and the transparent electrodes 210 and 220 of the second transparent substrate 201 are formed, respectively, and arrangement morphologies thereof, other configured elements were omitted for clarity from FIGS. 10 and 11. Referring to FIG. 10, the first transparent electrodes 110 and the second transparent electrodes 120, which have bar patterns, are repeatedly arranged in Y-axis direction on the other side of the first transparent substrate 101 (see FIG. 5A), while the third transparent electrodes 210 and the fourth transparent electrodes 220, which have bar patterns, are repeatedly arranged in X-axis direction on the other side of the second transparent substrate 201 (see FIG. 5B). One side of the second transparent substrate 201 is bonded to the other side of the first transparent substrate 101 by the adhesive layer 230 (see FIG. 2). On the other hand, as shown in FIG. 11, the first transparent electrodes 110 and the second transparent electrodes 120, which have diamond-shaped patterns, are repeatedly arranged in Y-axis direction on the other side of the first transparent substrate 101, while the third transparent electrodes 210 and the fourth transparent electrodes 220, which have diamond-shaped patterns, are repeatedly arranged in X-axis direction on the other side of the second transparent substrate 201. One side of the second transparent substrate 201 is bonded to the other side of the first transparent substrate 101 by the adhesive layer 230 (see FIG. 2). As such, a touch screen having two transparent substrates with different arrangement directions of transparent electrodes may more precisely sense a position of input signal.

A touch screen according to the present invention is fabricated by designing the touch screen to control an image displayed on an image display unit on both sides of the touch screen, to thereby overcome an obscured screen problem due to an input means such as a finger of human being.

In addition, since the electrode wires are gathered in the bent region of the transparent substrate, an area of a bezel region may be minimized to thereby utilize an active area more broadly.

Moreover, when the electrode wires are concentrated at one end of the bent region, a single control unit may easily execute integrated control and a size of an assistant device on which the touch screen is mounted, may be reduced.

Furthermore, the transparent electrodes and the electrode wires are simultaneously formed on the transparent substrate, and the transparent substrate is fabricated to be folded after forming the image display unit and the transparent electrodes on the transparent substrate, thereby embodying a double-sided controllable touch screen. Therefore, the present invention has advantages of enhancing production yield while reducing process time of the touch screen.

Although the preferred embodiments of the present invention have been disclosed for illustrative purposes, the touch screen 100 according to the present invention and its manufacturing process are not particularly limited to the foregoing. Those skilled in the art will appreciate that a variety of different modifications, additions and substitutions are possible, without departing from the scope and spirit of the invention.

Accordingly, simple modifications and changes of the present invention should also be understood as falling within the present invention, the scope of which is defined in the appended claims and their equivalents.

What is claimed is:

1. A touch screen, comprising:
a first transparent substrate that is partitioned into a first region, a second region and a first bent region present between the first region and the second region, and is folded by the first bent region to allow one side of the first region to face one side of the second region;
first transparent electrodes formed on the other side of the first region in the first transparent substrate;
first electrode wires extending from the first transparent electrodes toward the first bent region;
second transparent electrodes formed on the other side of the second region in the first transparent substrate;
second electrode wires extending from the second transparent electrodes toward the first bent region;
a first image display unit formed on one side of the first region in the first transparent substrate; and
a second image display unit formed one side of the second region in the first transparent substrate.

2. The touch screen as set forth in claim 1, further comprising:
a protective layer formed on the other side of the first transparent substrate to be applied to the first transparent electrodes and the second transparent electrodes; and
an adhesive member interposed between the first image display unit and the second image display unit.

3. The touch screen as set forth in claim 1, further comprising:
a second transparent substrate that is partitioned into a third region corresponding to the first region, a fourth region corresponding to the second region, and a second bent region corresponding to the first bent region, which is interposed between the third region and the fourth region, and is stacked over the first transparent substrate to allow one side of the second transparent substrate to face the other side of the first transparent substrate;
third transparent electrodes formed on the other side of the third region in the second transparent substrate;
third electrode wires extending from the third transparent electrodes toward the second bent region;
fourth transparent electrodes formed on the other side of the fourth region in the second transparent substrate;
fourth electrode wires extending from the fourth transparent electrodes toward the second bent region; and
an adhesive layer bonding the other side of the first transparent substrate to one side of the second transparent substrate.

4. The touch screen as set forth in claim 1, wherein the first transparent electrodes have bar patterns, rectangular patterns or diamond-shaped patterns, which are repeatedly arranged.

5. The touch screen as set forth in claim 1, wherein the second transparent electrodes have bar patterns, rectangular patterns or diamond-shaped patterns, which are repeatedly arranged.

6. The touch screen as set forth in claim 1, wherein the first transparent electrodes and the second transparent electrodes are formed of a conductive polymer.

7. The touch screen as set forth in claim 6, wherein the conductive polymer includes poly-3,4-ethylenedioxythiophene/polystyrene sulfonate (PEDOT/PSS), polyaniline, polyacetylene or polyphenylenevinylene.

8. The touch screen as set forth in claim 3, wherein the third transparent electrodes have bar patterns, rectangular patterns or diamond-shaped patterns, which are repeatedly arranged.

9. The touch screen as set forth in claim 3, wherein the fourth transparent electrodes have bar patterns, rectangular patterns or diamond-shaped patterns, which are repeatedly arranged.

10. The touch screen as set forth in claim 3, wherein the third transparent electrodes and the fourth transparent electrodes are formed of a conductive polymer.

11. The touch screen as set forth in claim 10, wherein the conductive polymer includes poly-3,4-ethylenedioxythiophene/polystyrene sulfonate (PEDOT/PSS), polyaniline, polyacetylene or polyphenylenevinylene.

12. The touch screen as set forth in claim 1, wherein an image displayed on the first image display unit corresponds to an image displayed on the second image display unit.

13. The touch screen as set forth in claim 1, wherein the first transparent electrodes and the first electrode wires are simultaneously formed, while the second transparent electrodes and the second electrode wires are simultaneously formed.

14. The touch screen as set forth in claim 1, wherein the first electrode wires and the second electrode wires extend toward the first bent region and then are gathered at one end of the first bent region.

15. The touch screen as set forth in claim 3, wherein the third transparent electrodes and the third electrode wires are simultaneously formed, while the fourth transparent electrodes and the fourth electrode wires are simultaneously formed.

16. The touch screen as set forth in claim 3, wherein the third electrodes wires and the fourth electrode wires extend toward the second bent region, and then are gathered at one end of the second bent region.
